(19) United States
(12) Patent Application Publication
(10) Pub. No.: US 2006/0119087 A1
(43) Pub. Date: Jun. 8, 2006

(54) Gas generator

(76) Inventors: Uwe Blessing, Nuernberg (DE); Jochem Gaertner, Nuernberg (DE); Peter Lehniger, Erlangen (DE); Marc Alexander Winterhalder, Garching / Alz (DE)

Correspondence Address: DELPHI TECHNOLOGIES, INC., M/C 480-410-202, PO BOX 5052, TROY, MI, 48007, US

(21) Appl. No.: 11/289,777

(22) Filed: Nov. 29, 2005

(30) Foreign Application Priority Data
Dec. 8, 2004 (EP) 04029065.2

(51) Int. Cl. B60R 21/26

(52) U.S. Cl. 280/736

(57) ABSTRACT

The present invention relates to a gas generator, in particular for airbag modules in motor vehicles, comprising two generator stages which can be ignited independently of one another and each of which includes in its own pressure housing at least one igniter, at least one propellant charge and at least one combustion chamber. The two generator stages are arranged at least partly in a common filter housing together with a common filter unit arranged outside the pressure housing and a first generator stage is made in annular shape. A second generator stage is arranged centrally with respect to the first generator stage and is disposed at least partly above the first generator stage.

### TECHNICAL FIELD

The present invention relates to a gas generator, in particular for airbag modules in motor vehicles, comprising two generator stages which can be ignited independently of one another and each of which includes in its own pressure housing at least one igniter, at least one propellant charge and at least one combustion chamber.

### BACKGROUND OF THE INVENTION

Such multi-stage gas generators are already known from the prior art. One or more generator stages can be ignited depending on the respective demands. The same gas generator can thus be used in vehicle applications for different airbag modules and different vehicle types. However, with the aid of a corresponding control, a decision can also be made with a gas generator installed with an airbag module in a vehicle in dependence on the magnitude of the impact, on different accident conditions or on the situation of use, e.g. the manner of seat occupation, which generator stages are ignited at which time.

With such multi-stage gas generators, it must be prevented by the geometrical arrangement and the design of the individual generator stages that, when one generator stage is ignited, the propellant charge of the other generator is also unintentionally ignited (sympathetic ignition). The housings of the individual generator stages must therefore be correspondingly insulated from one another, with the weight of the gas generator, however, simultaneously being kept as low as possible. Since such gas generators are mass products produced in very high volumes, the manufacture of the generator should moreover be as simple as possible despite these aforementioned demands. As few different parts as possible should in particular be used.

### SUMMARY OF THE INVENTION

It is therefore the object of the present invention to provide a gas generator of the initially named kind which is as light and as compact as possible, which can be manufactured easily and cost-favorably and in which an unintentional triggering of the combustion process in the respective other combustion chamber (sympathetic ignition) is reliably avoided.

This object is satisfied in accordance with the invention in that the two generator stages are arranged at least partly in a common filter housing together with a common filter unit arranged outside the pressure housing and in that a first generator stage is made in the form of an annulus and a second generator stage is arranged centrally with respect to the first generator stage and is disposed at least partly above the first generator stage.

This at least partly provided arrangement of the two generator stages over one another (so-called “stage-on-stage” design) saves room and permits an arrangement which is as symmetrical as possible overall. An additional chamber, which the gases have to flow through, can be provided outside the combustion chambers at the interior of the filter housing due to the arrangement of the two generator stages in a common filter housing including the filter unit. Said gases are not only filtered in this process, so that a gas as free of particles as possible can enter into the airbag, but can also cool down. Since a lower pressure prevails in the outwardly disposed filter housing than in a housing simultaneously serving as a combustion chamber, lower demands are made on the wall thickness of the filter housing, which reduces the manufacturing costs and also the weight. Due to the arrangement of the filter unit outside the pressure housings, the latter can moreover be made relatively small, whereby material and weight are in turn saved. It was recognized that it is not necessary to arrange the filter unit inside a pressure housing, but that it is rather sufficient to provide a comparatively thin-walled filter housing which can then moreover advantageously be used to satisfy specific additional functions.

Preferred embodiments of the invention are described in the dependent claims and in the description in conjunction with the enclosed drawing.

In accordance with a preferred embodiment of the invention, the second generator stage has the form of a plurality of cylinders, in particular of two cylinders with different radii and arranged coaxially over one another. A lower cylinder can, for example, be provided whose radius corresponds to the radius of the central opening of the annulus-shaped first generator stage, which will also be termed the interior space in the following, so that the interior space of the ring is ideally utilized for the second generator stage.

The second generator stage can have the shape of a mushroom or of a T in the longitudinal section. This is, for example, the case when the second generator stage is—as described above—made from a lower cylinder of a smaller diameter on which an upper cylinder having a larger diameter is arranged.

It is advantageous for reasons of saving space to arrange the second generator stage at least partly inside the ring formed by the first generator stage. The second generator stage can in particular completely fill the interior space of the said ring.

The volume of the first generator stage is preferably larger than that of the second generator stage. A reverse dimensioning is naturally also conceivable. Generally, volumes of different sizes will be preferred in order to have a larger choice of different ignition scenarios available.

In accordance with a further preferred embodiment, the pressure housings of the two generator stages can have at least one common wall. Not only material and weight is thereby saved, but the manufacture of the gas generator can also be simplified.

For example, the pressure housing of the second generator stage can be formed by a wall of the pressure housing of the first generator stage and by a cover element which is in particular placed centrally onto the pressure housing of the first generator stage and which covers the interior space of the ring formed by the first generator stage. In this manner, the aforementioned mushroom-shaped longitudinal section is obtained, with the “umbrella” of the mushroom being formed by the cover element placed onto the pressure housing of the first generator stage, while the “shaft” is formed by the cylindrical interior space of the ring formed by the first generator stage. This embodiment is particularly advantageous, since the manufacture and connection of the two pressure housings is particularly simple. The two pressure housings can be made up of only two housing parts and a base plate, with the one housing part forming the annulus-shaped, upwardly closed structure of the first generator stage and the other housing part being formed by the cover element which is placed onto the ring, in particular centrally placed, of the first generator stage and can be welded to said ring.

At least one deflection element, which can in particular be ring-shaped, can be provided between the first generator stage and the filter unit. Such a deflection element, preferably made as a thin metal sheet, can lie, for example, on outflow openings of the first generator stage and direct the gas flowing out of it into the filter unit such that it can expand, and thus cool before filtering, on the on hand, and has to cover a filter path which is as long as possible, on the other hand. With a skilful placement of the deflection element, it can be pressed away from the outflow openings by the gas flowing out such that the cross-section of the flow path is adopted in dependence on the outflow pressure, whereby a pressure stabilization is achieved.

The filter unit and the two generator stages preferably at least substantially completely fill the filter housing. An optimum utilization of space is thereby ensured.

A particularly skilful arrangement provides that the filter unit is arranged above the first generator stage and in particular lies on its pressure housing.

The filter unit can, for example, be ring-shaped and surround the second generator stage. A substantially cylindrical filter housing can thereby be completed filled overall, when the filter ring and the second generator stage are made such that the second generator stage at least substantially completely fills the interior space of the filter ring. A particularly compact gas generator of relatively low construction size thereby results.

If the filter unit surrounds the second generator stage in annular shape and simultaneously lies on the pressure housing of the first generator stage, outflow openings of the pressure housings of both generator stages can be arranged in housing regions adjacent to the filter unit so that the gases can be supplied directly to such a filter ring.

The pressure housing of the first generator stage can, in accordance with a further preferred embodiment, have outflow openings which lie beneath the filter unit.

In accordance with a further advantageous embodiment, each pressure housing can be directly in communication with a space containing the filter unit via its own outflow openings. In this manner, the two generator stages are completely independent of one another and can in particular—at least in principle—each be ignited alone, without gases flowing out of the pressure housing of the one generator stage having to be guided through the other generator stage, which generally brings along the risk of an unwanted sympathetic ignition of the other generator stage.

In accordance with an alternative embodiment, one of the two generator stages can only be indirectly in communication with a space including the filter unit via the other generator stage. One or more communication openings are preferably formed in a common wall of the two pressure housings.

The pressure housing of the second generator stage preferably has radial outflow openings. This is in particular of advantage when the filter unit is ring-shaped and at least partly surrounds the second generator stage, since then the gas flowing out of the second generator stage can flow radially into the filter unit.

The igniters of the two generator stages can be secured to a common base plate, which simplifies the manufacture of the gas generator. The stability of the gas generator is moreover increased overall. The igniters can in particular be placed into recesses of the common base plate provided for this purpose and be secured there.

It is very particularly advantageous to form weld connections between the components forming the housings in each case by the same welding process. In particular capacitor discharge welding, laser welding, friction welding or resistance welding can be considered. The use of the same welding process for all connections saves time and thus costs in the manufacture of the gas generator in accordance with the invention. Depending on the process used and on the geometry of the generator stages, optionally even a plurality of weld connections can be formed in one workstep.

The filter housing is preferably made as an outer housing of the generator. An additional outer housing of the generator is therefore not necessary, which saves material and thus costs, weight and installation space.

In accordance with an advantageous further development of the invention, the filter housing can have a securing flange to attach the gas generator to an airbag module. The filter housing can thus be used as an outer housing of the generator without an additional connection piece being necessary for the attachment to the airbag module.

It is particularly advantageous for outflow openings of the filter housing to be provided in an upper region of the filter unit. Such an arrangement is in particular to be preferred when the filter unit also forms the outer housing of the generator, since the gas should flow out of the gas generator as far toward the top as possible, but still in a radial direction, for an optimum unfolding of the airbag.

In accordance with a further preferred embodiment of the invention, the filter housing can be expanded by the gas pressure generated by means of the generator stages so that it can assist a pressure buffer function. The pressure of the gas flowing out can be reduced by such an expansion of the filter housing such that the airbag is inflated with a lower force than with a filter housing of a less resilient design. This is above all of particular importance at high environmental temperatures, in comparison with lower environmental temperatures, which have the consequence of a higher maximum pressure which would have a full effect on the inflation behavior of the airbag without a pressure buffer. The dilatability of the filter housing can be set such that the inflation behavior is less dependent on the environmental temperature, that is such that the airbag does not behave too “aggressively” in summer and behaves sufficiently “dynamically” in winter. It must also be taken into account here that current regulations require a problem-free function and a simultaneous observation of safety requirements over a temperature range from −35° C. to +85° C., i.e. the gas generator must also be designed for very low temperatures. The pressure buffer function of the filter housing in particular ensures that the increased pressure development does not result in a bursting of the filter housing at very high temperatures.

### BRIEF DESCRIPTION OF THE DRAWINGS

The present invention will be described in the following with reference to a preferred embodiment and to the enclosed Figures, with these showing:

FIG. 1 is an axial section through a gas generator in accordance with the invention before ignition; and

FIG. 2 is an axial section through the gas generator of FIG. 1 during the combustion of the propellant charges.

### DESCRIPTION OF THE PREFERRED EMBODIMENT

The gas generator in accordance with the invention is of substantially cylindrical design overall.

A first generator stage 20 is made in annular shape and is disposed in the lower region of the gas generator. Two ring-shaped, coaxially arranged side walls and one annular upper part are made in one piece with one another and form, together with a base plate 46 and a support ring 48 radially overlapping the base plate 46, a pressure housing 26 of the first generator stage 20.

The base plate 46 lies above the support ring 48 and radially inside the radial outer side wall of the pressure housing 6 welded to the support ring 48. The radially inner side wall is welded to the base plate 46.

For the assembly of the gas generator, in this case the base plate 46 already provided with the two igniters 22, 32 is first placed onto the combustion chamber 24 with the pressure housing 26 filled with a propellant charge, with an insulation, e.g. in the form of an air gap, being provided at the outer edge of the base plate 46. In the following step, the support ring 48 is placed onto the base plate 46 and welded thereto using a capacitor discharge (CD) welding process. Next, the radially outer wall of the pressure housing 26 is likewise welded to the support ring 48 using a CD welding process. Subsequently, the two generator stages 20, 30 completed by a cover element 39 and the filter unit 50 are pressed into the filter housing 56 which is then welded to the outside of the radially outer side wall of the housing 26. In the preceding steps, a laser welding process or another suitable welding process can be used instead of a CD welding process.

The interior of the housing 26 of the first generator stage 20 forms an annular combustion chamber 24 in which a propellant charge not shown in the Figure is stored in the form of pressed fuel pellets. A ring seal not shown in the Figure is disposed between the base plate 46 and the support ring 48 to seal the ring-shaped combustion chamber 24.

Alternatively, instead of this two-part arrangement of base plate 46 and support ring 48, a one-piece base plate made with steps and having an axially downwardly offset outer edge region—on an orientation in accordance with the Figure—with the radially outer side wall of the housing 26 being welded to the edge region of the base plate and the radially inner side wall of the housing 26 being welded to the central region of the base plate. Additional measures to seal the combustion chamber 24 can be dispensed with in this process.

In accordance with a further alternative, the base plate can also be made in one-piece and without steps and e.g. be planar prior to the installation. In this variant, the radially outer side wall of the housing 26 is made recessed in the axial direction with respect to the radially inner side wall of the housing 26. When the gas generator is assembled, the radially inner side wall of the housing 26 can first be welded to the base plate 46, e.g. with the aid of a CD welding process, with an air gap remaining between the radially outer wall and the base plate for insulation. In a next step, the base plate 46 is then pressed onto the housing 26 so that it bends upwardly at its radially outer edges and contacts the radially outer wall of the housing 26. The base plate 46 can now in turn be welded, e.g. with the aid of a CD welding process, along this contact line. The base plate 46 can be slightly arched in the finished, mounted state and can merge outwardly into a securing flange.

In all cases, it can be ensured by a corresponding dimensioning of the components that they are pressed together in the axial direction or are under stress in the state closed by welding.

A cover element 39 in the form of a downwardly open circular cylinder lies on the pressure housing 26 of the first generator stage 20 and is connected to it at weld spots 60. The cover element 39 is arranged concentrically to the pressure housing 26 of the first generator stage 20, with the diameter of the cover element 39 being larger than the diameter of the central opening of the annular first generator stage 20 and amounting to somewhat more than half the outer diameter of the first generator stage 20.

The cover element 39 forms a pressure housing 36 for a second generator stage 30 together with the radially inner side wall and part of the upper side of the pressure housing 26 of the first generator stage 20, i.e. the two generator stages 20, 30 or their pressure housings 26, 36 have a common wall region 62. The base plate 46 is likewise common to both pressure housings 26, 36. The central opening of the annular first generator stage 20 and the interior space of the cover element 39 itself form a combustion chamber 34 of the second generator stage 30 in which a second propellant charge (likewise not shown) is disposed in the form of pressed fuel pellets.

Overall, the second generator stage 30 or its pressure housing 36 has a longitudinal section in the form of a T or of a mushroom, with the cross-bar of the T being formed by the cover element 39.

On the assembly of the gas generator in accordance with the invention, the establishing of the weld connections 60 preferably takes place by capacitor discharge welding, with only this welding process being used for which the design of the gas generator explained above is particularly suitable. A particularly simple and cost-favorable mass production of the gas generator is hereby made possible. An establishment of the connections partly or exclusively by means of laser welding is likewise conceivable.

One respective igniter 22, 32 is arranged in each pressure housing 26, 36. Both igniters 22, 32 are inserted into circular recesses of the common base plate 46 intended therefor and are fastened there. The igniter 32 of the second generator stage 30 is seated at the center of the common base plate 46 and consequently centrally with respect to both generator stages 20, 30 and thus to the gas generator overall.

A likewise ring-shaped filter unit 50 is disposed on the pressure housing 26 of the first generator stage 20. The filter unit 50 and the two generator stages 20, 30 are coaxially aligned and thus have a common central axis 64, with the outer diameter of the ring-shaped filter unit 50 substantially corresponding to the outer diameter of the first generator stage 20. The inner diameter and height of the ring-shaped filter unit 50 in turn substantially correspond to the outer diameter and to the height of the cover element 39 so that the central opening of the filter unit 50 is completely filled by the second generator stage 30.

An annular deflection element 59 made up of a thin metal sheet whose ring width substantially corresponds to that of the filter unit 50 is disposed in the filter space 54 between the filter unit 50 and the first generator stage 20. The purpose of this deflection element 59 will be explained in more detail later.

The two generator stages 20, 30 and the filter unit 50 are disposed to a large part in a filter housing 56 which is downwardly open and already merges into a radial flange 44 before reaching the base plate 46 in order to attach the gas generator to an airbag module.

The filter housing 56 has a substantially cylindrical shape and is practically completely filled by the two generators 20, 30 and the filter unit 50. The filter unit 50 does not adjoin the filter housing 56 directly upwardly and at its radial outer side, but rather a narrow intermediate space is provided in each case.

The filter housing 56 is only welded to the radially outer wall of the ring-shaped housing 26. In contrast, only the upper side of the filter housing 56 contacts the upper side of the cover element 39 so that the upper side of the filter housing 56 can move away from the cover element 39, i.e. the filter housing 56 can expand, due to the gas pressure arising in the filter space 54. The filter housing 56 can hereby in particular satisfy the pressure buffer function explained in the introductory part.

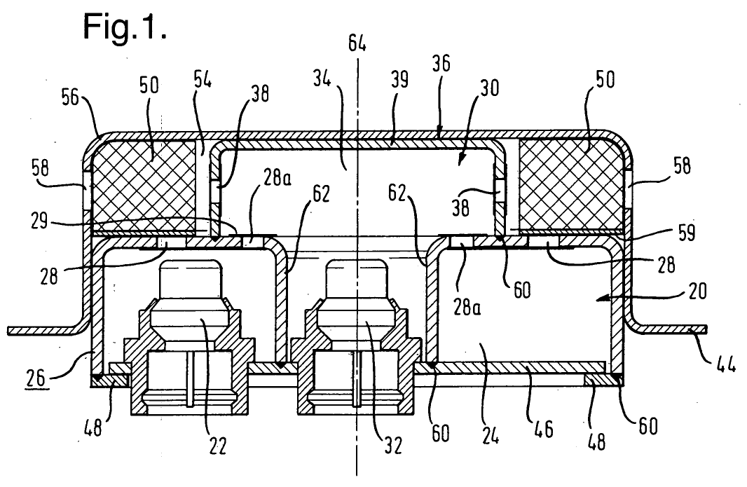

The pressure housing 26 of the first generator stage 20 has outflow openings 28 which are arranged at regular intervals in the upper side of the pressure housing 26. The outflow openings 28 are disposed inwardly offset somewhat outside the center, considered in the radial direction, beneath the deflection element 59 arranged in turn beneath the ring-shaped filter unit 50. In the state shown in FIG. 1 prior to the ignition of the propellant charge(s), the outflow openings 28 are covered by the deflection element 59.

In a possible embodiment, the pressure housing 36 of the second generator stage 30 has only radial outflow openings 38 which are provided in the cover element 39. The outflow openings 38 are uniformly spaced apart in the peripheral direction and open directly into the interior space 54 of the filter housing 56 containing the ring-shaped filter unit 50, with the ring-shaped filter unit 50 lying directly in front of the outflow openings 38.

In accordance with an alternative embodiment, connection openings 28a, which establish a connection between the two generator stages 20, 30, can be provided instead of the outflow openings 38 in the pressure housing 36 of the second generator stage 30. Said connection openings are disposed in the part 62 of the upper side of the ring-shaped pressure housing 26 common to both pressure housings 26, 36 and connect the upper region of the second generator stage 30 to the first generator stage 20. The connection openings 28a are covered by a steel band 29 in the direction of the combustion chamber 34 of the second generator stage 30.

For illustration of the two variants, both the connection openings 28a and the outflow openings 38 of the pressure housing 36 of the second generator stage 30 are shown in the Figures; however, it is preferably a case of two alternative embodiments, with it, however, generally also being possible to combine both variants.

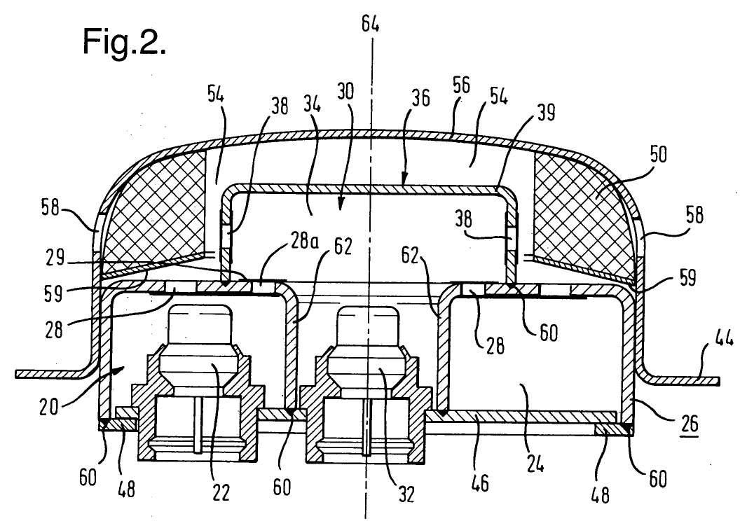

In FIG. 2, the gas generator of FIG. 1 is shown after the first, and possibly also the second generator stage, has been ignited. The deflection element 59 is raised and the filter unit 50 is deformed by the gas flowing out through the outflow openings 38, as will be explained in more detail in the following. In addition, the whole filter housing 56 expands due to the pressure prevailing in the filter space 54.

Depending on whether connection openings 28a are provided in the common wall 62 of the two pressure housings 26, 36 or not, different ignition scenarios are feasible.

In both cases, the first generator stage 20 can be ignited alone. In this process, the gas arising in the combustion chamber 24 of the first generator stage 20 flows through the outflow openings 28 past the deflection element 59 raised by the gas to the ring-shaped filter unit 50 through which gas consequently flows substantially in the radial direction from the inside to the outside. Further gas deflection devices or gas guide devices can be provided which are not shown, which are arranged above the outflow openings 28 in the filter space 54 and ensure that the gas flows radially outwardly—and not radially inwardly in the direction of the outflow openings 38 of the second generator stage 30—and flows ideally through the filter unit 50 in this process.

If only the outflow openings 38 are provided in the pressure housing 36 of the second generator stage 30, the two generator stages 20, 30 can be ignited either offset in time or simultaneously. In both cases, the gases generated in the second generator stage 30 flow directly through the outflow openings 38 to the filter unit 50. The two generator stages 20, 30 are thus completely independent of one another in particular in the sense of avoidance of sympathetic ignition and an ignition of only the second generator stage 30 is in particular also feasible. A steel band to prevent a cross-ignition is preferably provided on the outside of the second generator stage 30 and covers the outflow openings 38.

If, in contrast, only the connection openings 28a are provided between the two pressure housing 26, 36, the gases arising in the second generator stage 30 enter into the first generator stage 20 on a simultaneous activation of the two igniters 22, 32 or one offset in time. The steel band 29 prevents a reverse gas flow from the first generator stage 20 into the second generator stage 30 so that, if only the first generator stage 20 is ignited, the second generator stage 30 is not also unintentionally ignited. A sympathetic ignition or cross-ignition is thus also avoided in this case. The gases arising in the two generator stages 20, 30 then flow together through the outflow openings 28 of the first generator stage 20 to the filter unit 50.

In each of the cases described, the gases flowing out of the first generator stage 20 are first deflected radially inwardly by the deflection element 59. As can be recognized in FIG. 2, the outflowing gas presses the deflection metal sheet 59 radially inwardly and upwardly in the direction of the filter unit 50. The filter unit 50 is hereby compressed and/or the filter housing 56 is expanded. An air gap, through which the gas flow upwardly into the space 54, is created in this manner in the inner space 54 of the filter housing 56 between the deflection element 59, which presses the filter unit 50 upwardly, and the upper side of the housing 26. Depending on how high the pressure is under which the gas arising in the first generator stage 20 stands, the deflection element 59 is raised more or less pronouncedly. At a higher pressure, a larger gap with a correspondingly larger flow cross-section is created in this manner, which then results in a pressure drop and, due to the elasticity in particular of the filter housing 56 and/or of the filter unit 50, in a springing back of the deflection element 59, which in turn brings along an increase in pressure and a repeated enlarging of the flow cross-section. The pressure is thereby stabilized overall. In addition, the gases are forced by the deflection element 59, to flow not on the shortest path from the outflow openings 28 in the pressure housing 26 to the outflow openings 58 in the filter housing 56, but to pass through the whole filter unit 50 in the radial direction, whereby the filter effect is optimized. The deflection element 59 furthermore ensures that the filter unit 50 is pressed upwardly toward the inner side of the upper wall of the housing 56, whereby an unwanted gap formation and a bypassing of the filter unit 50 is avoided.

The generated gases exit the gas generator in every case through the radial outflow openings 58 of the filter housing 56 arranged at the level of the filter unit 50 and thus in the upper region of the gas generator.

1. A gas generator, in particular for airbag modules in motor vehicles, comprising two generator stages which can be ignited independently of one another, each of which includes in its own pressure housing at least one igniter, at least one propellant charge and at least one combustion chamber and which are arranged at least partly in a common filter housing together with a common filter unit arranged outside the pressure housing,
wherein a first generator stage is made in annular shape and a second generator stage is arranged centrally with respect to the first generator stage and is disposed at least partly above the first generator stage.

2. A gas generator in accordance with claim 1, characterized in that the second generator stage has the form of a plurality of cylinders arranged coaxially above one another and having different radii.

3. A gas generator in accordance with claim 1, characterized in that the second generator stage has the shape of a mushroom or of a T in the longitudinal section.

4. A gas generator in accordance with claim 1, characterized in that at least one deflection element, in particular a ring-shaped deflection element, is arranged between the filter unit and the first generator stage.

5. A gas generator in accordance with claim 1, characterized in that the second generator stage is disposed at least partly inside the ring formed by the first generator stage.

6. A gas generator in accordance with claim 1, characterized in that the second generator stage completely fills the interior space of the ring formed by the first generator stage.

7. A gas generator in accordance with claim 1, characterized in that the volume of the first generator stage is larger than that of the second generator stage.

8. A gas generator in accordance with claim 1, characterized in that the pressure housings of the two generator stages have at least one common wall.

9. A gas generator in accordance with claim 1, characterized in that the pressure housing of the second generator stage is formed by a wall of the pressure housing of the first generator stage and by a cover element which is in particular placed centrally on the pressure housing of the first generator stage and which covers the interior space of the ring formed by the first generator stage.

10. A gas generator in accordance with claim 1, characterized in that the filter unit and the two generator stages at least substantially completely fill the filter housing.

11. A gas generator in accordance with claim 1, characterized in that the filter unit is arranged above the first generator stage and in particular lies on its pressure housing.

12. A gas generator in accordance with claim 1, characterized in that the filter unit is made in ring shape and surrounds the second generator stage.

13. A gas generator in accordance with claim 12, characterized in that the second generator stage at least substantially completely fills the interior space of the filter ring.

14. A gas generator in accordance with claim 1, characterized in that the pressure housing of the first generator stage has outflow openings which are disposed beneath the filter unit.

15. A gas generator in accordance with claim 1, characterized in that each pressure housing is directly in communication with a space containing the filter unit via its own outflow openings.

16. A gas generator in accordance with claim 1, characterized in that one of the two generator stages is exclusively or additionally indirectly in communication with a space containing the filter unit via the other generator stage, wherein at least one connection opening is preferably formed in a common wall of the pressure housings.

17. A gas generator in accordance with claim 1, characterized in that the pressure housing of the second generator stage has radial outflow openings.

18. A gas generator in accordance with claim 1, characterized in that the igniters of the generator stages are secured to a common base plate.

19. A gas generator in accordance with claim 1, characterized in that all weld connections between components forming the pressure housings are made by the same welding process, in particular by capacitor discharge welding or by laser welding.

20. A gas generator in accordance with claim 1, characterized in that the filter housing is made as an outer housing of a generator.

21. A gas generator in accordance with claim 1, characterized in that the filter housing has a securing flange for the attachment to an airbag module.

22. A gas generator in accordance with claim 1, characterized in that outflow openings of the filter housing are provided at the level of the filter unit.

23. A gas generator in accordance with claim 1, characterized in that the filter housing is in particular made in a dilatable manner to assist a pressure buffer function by the gas pressure which can be generated by means of the generator stages.
